(19) United States
(12) Patent Application Publication
(10) Pub. No.: US 2017/0302415 A1
(43) Pub. Date: Oct. 19, 2017

(54) METHOD AND DEVICE FOR MITIGATING INTER-CELL INTERFERENCE

(71) Applicant: LG ELECTRONICS INC., Seoul (KR)

(72) Inventors: Kungmin PARK, Seoul (KR); Heejeong CHO, Seoul (KR); Hyunsoo KO, Seoul (KR); Hyeyoung CHOI, Seoul (KR); Ilmu BYUN, Seoul (KR)

(73) Assignee: LG ELECTRONICS INC., Seoul (KR)

(21) Appl. No.: 15/509,839

(22) PCT Filed: Sep. 15, 2014
(86) PCT No.: PCT/KR2014/008554

§ 371 Date: Mar. 8, 2017

(51) Int. Cl. H04L 5/00; H04B 7/04

(52) U.S. Cl. CPC H04L 5/0032; H04B 7/0456

(57) ABSTRACT

Provided is a method for mitigating inter-cell interference. To this end, a method can comprise: when a transmission symbol which will be transmitted to a first receiver is Sₖ (k is an integer) and a transmission symbol which will be transmitted to a second receiver is Zₖ (k is an integer), a step for, with respect to a first pattern, transmitting symbol Sₖ to the first receiver through a first transmission antenna and transmitting symbol Sₖ* to the first receiver through a second transmission antenna; and a second signal transmission step for, with respect to a second pattern that is different from the first pattern, transmitting symbol Zₖ to the second receiver through a third transmission antenna and transmitting symbol Zₖ* to the second receiver through a fourth transmission antenna.

### BACKGROUND OF THE INVENTION

### Field of the Invention

The present invention relates to wireless communications, and more particularly, to a method and a device for mitigating inter-cell interference.

### Related Art

In a cellular network system, system performance may significantly change depending on the location of a terminal in a cell. Particularly, inter-cell interference may substantially degrade the performance of a terminal located on the boundary of the cell. Further, with higher frequency reuse efficiency, a high data transmission rate may be obtained in the center of the cell, while inter-cell interference becomes serious. Accordingly, the terminal on the boundary receives significant interference from a neighboring cell and thus has a greater decrease in signal-to-interference-plus-noise ratio (SINR).

In order to mitigate inter-cell interference in an orthogonal frequency-division multiple access (OFDMA) cellular network system, studies have been conducted on techniques for avoiding inter-cell interference, techniques for averaging inter-cell interference effects, and techniques for eliminating inter-cell interference.

In a current cellular network system, there are a large number of moving cells. Inter-cell interference may occur between moving cells and fixed cells. Methods are needed to mitigate interference between moving cells and fixed cells.

### SUMMARY OF THE INVENTION

One aspect of the present invention provides a method and a device for mitigating inter-cell interference.

Another aspect of the present invention provides a precoding method for mitigating inter-cell interference and a device using the same.

A method for mitigating cell interference according to one embodiment of the present invention may include: when a transmission symbol to be transmitted to a first receiver is Sₖ (k is an integer) and a transmission symbol to be transmitted to a second receiver is Zₖ (k is an integer), a first signal transmission operation of transmitting a symbol Sₖ to the first receiver through a first transmitting antenna and transmitting a symbol Sₖ* to the first receiver through a second transmitting antenna, according to a first pattern; and a second signal transmission operation of transmitting a symbol Zₖ to the second receiver through a third transmitting antenna and transmitting a symbol Zₖ* to the second receiver through a fourth transmitting antenna, according to a second pattern that is different from the first pattern.

The first signal transmission operation may include: transmitting a sequence {S₃ₖ, 0, S₃ₖ₊₁, 0, S₃ₖ₊₂, 0} to the first receiver through the first transmitting antenna; and transmitting a sequence {0, S₃ₖ*, 0, S₃ₖ₊₁*, 0, S₃ₖ₊₂*} through the second transmitting antenna, and the second signal transmission operation may include: transmitting a sequence {Z₃ₖ, 0, Z₃ₖ₊₁, 0, Z₃ₖ₊₂, 0} to the second receiver through the third transmitting antenna; and transmitting a sequence {0, Z₃ₖ₊₁*, 0, Z₃ₖ₊₂*, 0, Z₃ₖ*} through the fourth transmitting antenna.

The first signal transmission operation may include: transmitting a sequence {S₃ₖ, 0, S₃ₖ₊₁, 0, S₃ₖ₊₂, 0} to the first receiver through the first transmitting antenna; and transmitting a sequence {0, S₃ₖ*, 0, S₃ₖ₊₁*, 0, S₃ₖ₊₂*} through the second transmitting antenna, and the second signal transmission operation may include: transmitting a sequence {Z₃ₖ, 0, Z₃ₖ₊₁, 0, Z₃ₖ₊₂, 0} to the second receiver through the third transmitting antenna; and transmitting a sequence {0, Z₃ₖ₊₂*, 0, Z₃ₖ*, 0, Z₃ₖ₊₁*} through the fourth transmitting antenna.

The sequence may be allocated to a frequency resource or a time resource.

The first pattern and the second pattern may be changed according to a predetermined period.

According to the present invention, there are provided a method and a device for mitigating inter-cell interference.

According to the present invention, inter-cell interference between moving cells having a quickly changing channel state may be mitigated based on precoding of a transmitting end. Specifically, interference signals included reception signals of a receiving end may be averaged to fade out based on precoding of the transmitting end, without the receiving end performing averaging of interference. Further, interference in each of a plurality of reception symbols may be randomized.

One embodiment of the present invention provides a precoding method for mitigating inter-cell interference and a device using the same.

### BRIEF DESCRIPTION OF THE DRAWINGS

FIG. 1 is a conceptual view illustrating the movement of a moving cell.

FIG. 2 is a conceptual view illustrating a problem that occurs when interference between a moving cell and a fixed cell is controlled by a conventional inter-cell interference control method.

FIG. 3 is a conceptual view illustrating a method for mitigating interference between a moving cell and a fixed cell according to an embodiment of the present invention.

FIG. 4 illustrates a symbol and an interference signal received through a semi-static channel.

FIG. 5 illustrates a reception symbol and an interference signal according to one embodiment of the present invention.

FIG. 6 illustrates a symbol pattern according to one embodiment of the present invention.

FIG. 7 illustrates a symbol pattern according to another embodiment of the present invention.

FIG. 8 is a graph illustrating a packet error rate (PER) according to a signal-to-noise ratio (SNR) in the case where interference diversity is achieved according to one embodiment of the present invention.

FIG. 9 is a graph illustrating an SNR according to an SIR in a case where a symbol pattern is applied according to one embodiment of the present invention.

FIG. 10 is a graph illustrating an SNR according to an SIR in a case where a symbol pattern is applied according to another embodiment of the present invention.

FIG. 11 illustrates a symbol pattern according to still another embodiment of the present invention.

FIG. 12 illustrates resource allocation by a first cell according to FIG. 11.

FIG. 13 illustrates one embodiment of resource allocation by a second cell according to FIG. 11.

FIG. 14 illustrates another embodiment of resource allocation by the second cell according to FIG. 11.

FIG. 15 illustrates still another embodiment of resource allocation by the second cell according to FIG. 11.

FIG. 16 is a control flowchart illustrating a precoder allocation method according to one embodiment of the present invention.

FIG. 17 is a control flowchart illustrating a precoder allocation method according to another embodiment of the present invention.

FIG. 18 is a block diagram illustrating a wireless communication system according to one embodiment of the present specification.

### DESCRIPTION OF EXEMPLARY EMBODIMENTS

A wireless device may be stationary or mobile and may be denoted by other terms such as, user equipment (UE), mobile station (MS), user terminal (UT), subscriber station (SS), or mobile terminal (MT). Further, the terminal may be a portable device with a communication function, such as a cellular phone, a smartphone, a wireless modem, or a notebook computer, or may be a non-portable device, such as a personal computer (PC) or a vehicle-mounted device. A base station generally refers to a fixed station that communicates with a wireless device and may be denoted by other terms, such as evolved-NodeB (eNB), base transceiver system (BTS), or access point.

Hereinafter, applications of the present invention based on 3rd generation partnership project (3GPP) long term evolution (LTE) or 3GPP LTE-advanced (LTE-A) are described. However, these are merely examples, and the present invention may be applied to various wireless communication systems. Hereinafter, LTE includes LTE and/or LTE-A.

The present specification is described based on a communication network, and operations implemented in the communication network may be performed by a system (for example, a base station) responsible for the communication network in controlling the network and transmitting data or may be performed by a terminal linked to the network.

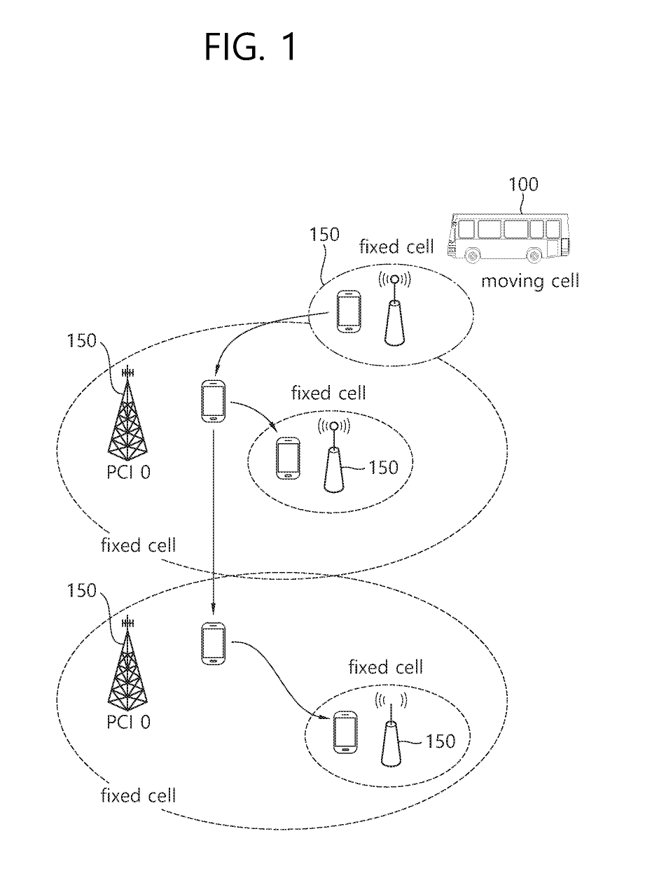

FIG. 1 is a conceptual view illustrating the movement of a moving cell.

In the following embodiments, a moving cell may denote a base station (BS) that moves, and a fixed cell may denote a BS that remains stationary at a fixed location. A moving cell may be denoted by a moving BS, and a fixed cell may be denoted by a fixed BS.

For example, a moving cell 100 may be a BS installed in a moving object, such as a bus. Based on buses running in Seoul, about 2000 moving cells 100 may be present. Therefore, interference between the moving cells 100 and fixed cells 150 is highly likely to occur in a current cellular network system.

For inter-cell interference (ICI) between fixed cells 150, resource division may be performed in view of the distance between a BS and a terminal in order to mitigate the inter-cell interference. Alternatively, interference may be mitigated by performing dynamic resource division or cooperative communication based on sharing channel information between cells.

However, it is difficult to apply the same methods for controlling interference between fixed cells 150 to the moving cell 100.

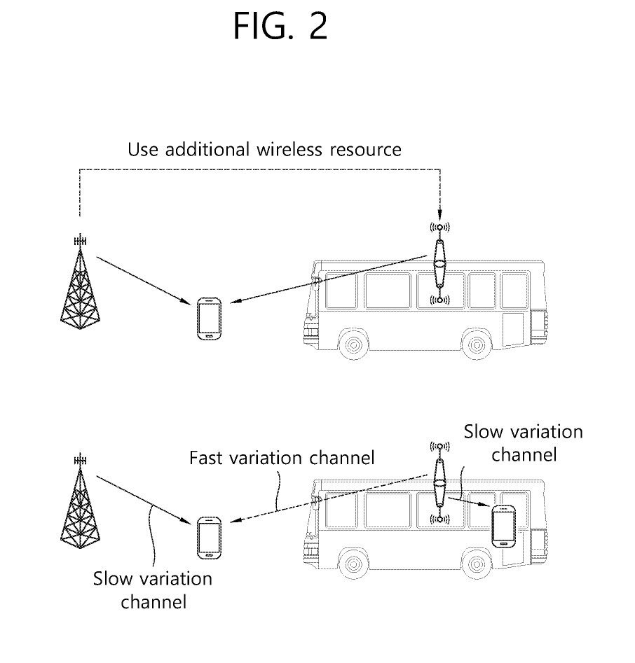

FIG. 2 is a conceptual view illustrating a problem that occurs when interference between a moving cell and a fixed cell is controlled by a conventional inter-cell interference control method.

In a moving cell, services are frequently provided through real-time traffic. Thus, interference control based on semi-static resource division may be inappropriate for the moving cell.

Referring to the upper part of FIG. 2, a moving cell may be connected to another cell based on a wireless backhaul. Thus, it may be difficult to use an inter-cell interference mitigation method based on dynamic resource division or cooperative communication through sharing of channel information. Specifically, in joint transmission (JT)/dynamic point selection (DPS), data to be transmitted to a terminal needs to be shared through a wired backhaul between BSs. However, data sharing between a moving cell and a fixed cell through the wireless backhaul needs the use of additional wireless resources and may be difficult to stably achieve according to a wireless channel condition. Thus, it may be difficult to mitigate interference between a fixed cell and a moving cell based on cooperative communication.

Referring to the lower part of FIG. 2, a channel between a moving cell and a fixed cell may be quickly changed by the movement of the moving cell. Thus, interference mitigation may be impossible through closed loop multiple-input and multiple-output (MIMO). Thus, it is necessary to develop a technique for controlling and reducing interference in a situation where sharing inter-cell signals and interference channel information is not smoothly performed. Particularly, open loop interference mitigation is needed to mitigate interference by a moving cell.

According to an embodiment of the present invention, inter-cell interference, specifically interference between a moving cell and a fixed cell, may be mitigated based on inter-cell interference randomizing and inter-cell interference averaging.

Inter-cell interference randomizing is a method of randomizing interferences from neighboring cells to approximate inter-cell interference by additive white Gaussian noise (AWGN). Inter-cell interference randomizing may reduce the effect of a channel decoding process by a signal from another user, for example, based on cell-specific scrambling and cell-specific interleaving.

Inter-cell interference averaging is a method of averaging all interferences from neighboring cells or averaging inter-cell interferences at channel coding block level through symbol hopping.

Further, an embodiment of the present invention provides a method of diversifying an interference signal affecting de-precoding of each symbol, changing the signal-to-interference ratio (SIR) of a signal in a quasi-static channel section, and securing interference diversity in the quasi-static channel section to obtain a diversity gain.

Generally, signal diversity refers to the standardization of received powers of signals by repetitively transmitting and receiving the same information through various channels. In signal diversity, an SINR change is reduced in a fading channel, and accordingly it is more likely to reconstruct information in the fading channel.

Interference diversity according to the present invention is conceptually similar to signal diversity, in which multiple interferences are simultaneously received through different channels to standardize the received powers of the interferences and an SINR change by interference is reduced. Accordingly, when the received power of an interference signal is high, the diversity gain of a signal is high.

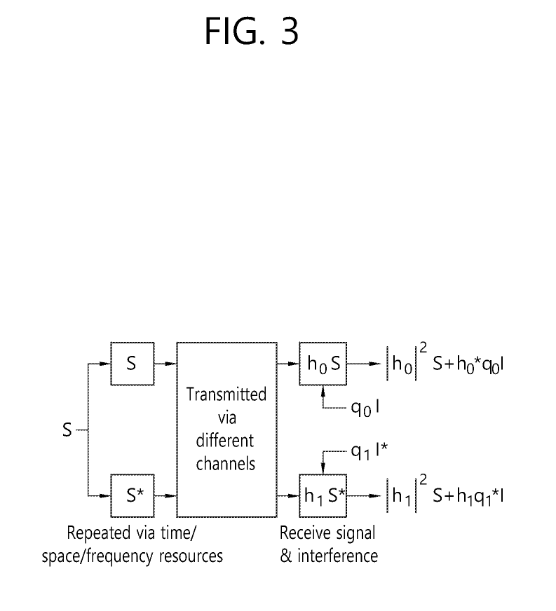

FIG. 3 illustrates that a signal is repetitively transmitted through different channels.

As illustrated, a transmitting end may transmit one transmission symbol (S, hereinafter, ‘first symbol’) and one modified symbol (S*, hereinafter, ‘second symbol’) to a receiving end, such as a terminal, through different channels, for example, different antennas. Here, the second symbol is the complex conjugate of the first symbol.

h₀ denotes a channel for a symbol between an antenna to transmit the first symbol and the receiving end, and h₁ denotes a channel for a symbol between an antenna to transmit the second symbol and the receiving end.

Here, I denotes an interference signal, and I* denotes the complex conjugate of the interference signal. q₀ denotes a channel for an interference signal between the antenna to transmit the first symbol and the receiving end, and q₁ denotes a channel for an interference signal between the antenna to transmit the second symbol and the receiving end.

The first symbol and the second symbol may be allocated to time, space, or frequency resources to be repetitively transmitted, and the transmitting end may receive a signal and interference.

As illustrated, when the first symbol is transmitted, the receiving end may receive |h₀|²S+h*₀q₀I along with an interference signal. When the second symbol is transmitted, the receiving end may receive |h₁|²S+h₁q₁*I along with an interference signal.

Ultimately, a symbol and an interference signal received by the receiving end may be represented by Equation 1.

$$\frac{{\vert {h}_{0} \vert}^{2} - {\vert {h}_{1} \vert}^{2}}{2} S + \frac{( {h}_{0}^{⋆} {q}_{0} + {h}_{1} {q}_{1}^{⋆} ) I}{2} \qquad [ Equation 1 ]$$

When a channel is in a semi-static state, in which the channel hardly changes, an interference diversity effect is reduced.

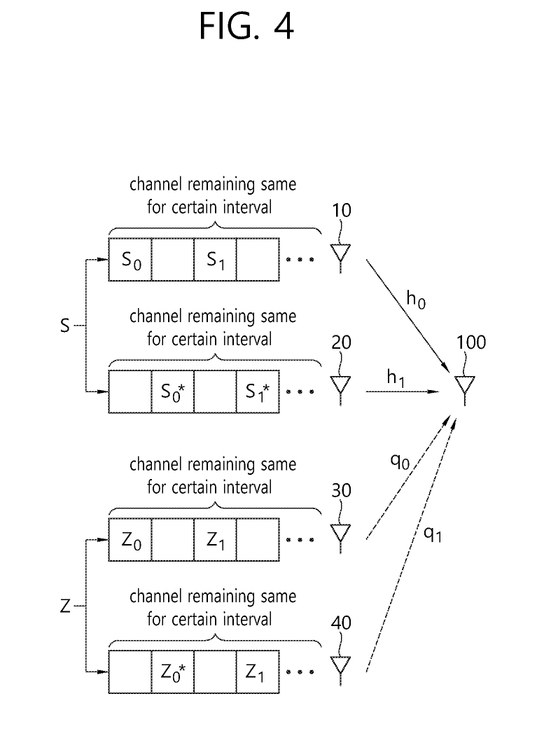

FIG. 4 illustrates a symbol and an interference signal received through a semi-static channel.

As illustrated, a terminal 100, which is a receiving end, may receive symbols (S) transmitted through two antennas and may receive signals transmitted through two antennas as interference signals (Z).

A first antenna 10 and a second antenna 20 may be antennas of a cell (hereinafter, ‘first cell’) providing a service to the terminal 100, and a third antenna 30 and a fourth antenna 40 may be antennas of a cell (hereinafter, ‘second cell’) transmitting symbols (Z) acting as interference signals to the terminal 100.

For example, when a fixed cell acts as an interference source to a terminal served by a moving cell, the first cell may be the moving cell and the second cell may be the fixed cell. On the contrary, when a moving cell acts as an interference source to a terminal served by a fixed cell, the first cell may be the fixed cell and the second cell may be the moving cell.

In FIG. 4, a row for symbols may denote time, space, or frequency resources for transmitting the symbols.

In a semi-static channel that remains the same for a certain interval, symbols S0, S1, etc. are transmitted through the first antenna 10, and modified symbols S₀*, S₁*, etc. of the symbols transmitted through the first antenna 10 are transmitted through the second antenna 20.

Symbols Z0, Z1, etc. are transmitted through the third antenna 30, and modified symbols Z₀*, Z₁*, etc. of the symbols transmitted through the third antenna 30 are transmitted through the fourth antenna 40.

For the terminal, the transmission symbols (S) transmitted in the first cell may be reception signals and the transmission symbols (Z) transmitted in the second cell may be interference signals.

Thus, in FIG. 4, h₀ denotes a channel between the first antenna 10 of the first cell and the terminal 100 served by the first cell; h₁ denotes a channel between the second antenna 20 of the first cell and the terminal 100 served by the first cell; q₀ denotes a channel between the third antenna 30 of the second cell and the terminal 100; and q₁ denotes a channel between the fourth antenna 40 of the second cell and the terminal 100.

Ultimately, reception symbols (Ŝ₀,Ŝ₁) received by the terminal may be represented by Equation 2.

$${\hat{S}}_{0} = {S}_{0} + \frac{( {h}_{0}^{⋆} {q}_{0} + {h}_{1} {q}_{1}^{⋆} ) {Z}_{0}}{{\vert {h}_{0} \vert}^{2} + {\vert {h}_{1} \vert}^{2}} \\ {\hat{S}}_{1} = {S}_{1} + \frac{( {h}_{0}^{⋆} {q}_{0} + {h}_{1} {q}_{1}^{⋆} ) {Z}_{1}}{{\vert {h}_{0} \vert}^{2} + {\vert {h}_{1} \vert}^{2}} \qquad [ Equation 2 ]$$

Referring to Equation 2, since the interference signals acting as interference to the reception symbols include the same coefficient

$$( \frac{( {h}_{0}^{⋆} {q}_{0} + {h}_{1} {q}_{1}^{⋆} )}{{\vert {h}_{0} \vert}^{2} + {\vert {h}_{1} \vert}^{2}} )$$

in the two symbols (Ŝ₀,Ŝ₁), it is considered that the symbols have the same SIR.

This means that a gain from the diversity of the entire packet is limited or reduced. When interference is significant in the semi-static channel, the terminal may continuously receive strong interference.

Hereinafter, a method of securing interference diversity by changing a repetitive pattern of an interference symbol, instead of with the same level of interference, is described.

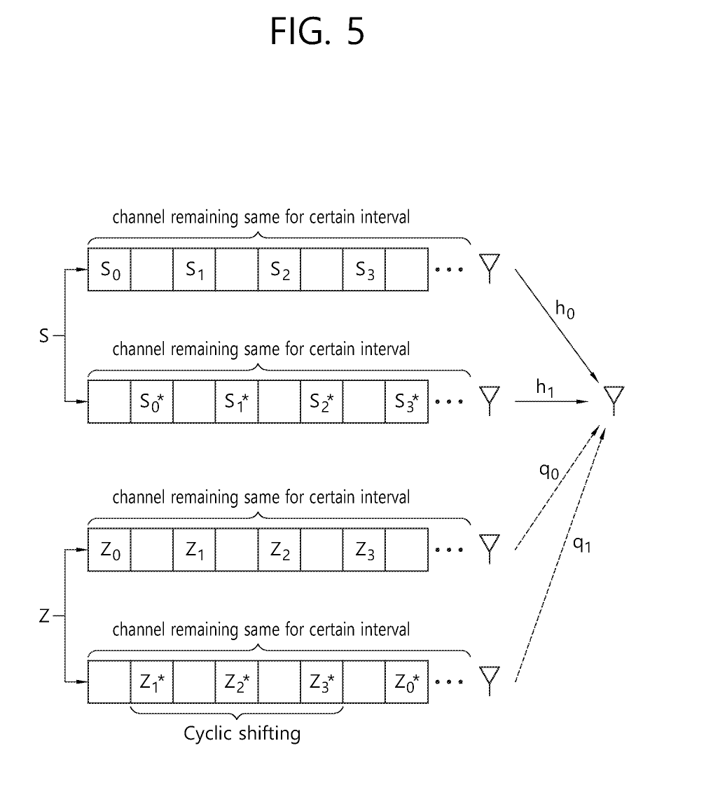

FIG. 5 illustrates a reception symbol and an interference signal according to one embodiment of the present invention.

As illustrated, in a semi-static channel that remains the same for a certain interval, symbols S₀, S₁, S₂, S₃, etc. are transmitted through a first antenna 10, and modified symbols S₀*, S₁*, S₂*, S₃**, etc. of the symbols transmitted through the first antenna are transmitted through a second antenna 20.

Symbols Z₀, Z₁, Z₂, Z₃, etc. are transmitted through a third antenna 30, and modified symbols Z₁*, Z₂*, Z₃*, Z₀*, etc. of the symbols transmitted through the third antenna are transmitted through a fourth antenna 40.

According to the embodiment of the present invention, the symbols transmitted through the fourth antenna are transmitted in order of Z₁*, Z₂*, Z₃*, Z₀*, etc. via the cyclic-shift of a conventional pattern of Z₀*, Z₁*, Z₂*, Z₃*. That is, a repetitive pattern of symbols that may act as interference signals to the terminal may be changed according to a certain order.

The repetitive pattern may be changed by a first cell and a second cell, which are transmitting ends, using different precoders.

When the repetitive pattern of symbols is changed, reception symbols (Ŝ₀,Ŝ₁) received by the terminal may be represented by Equation 3.

$${\hat{S}}_{0} = {S}_{0} + \frac{{h}_{0}^{⋆} {q}_{0} {Z}_{0} + {h}_{1} {q}_{1}^{⋆} {Z}_{2}}{{\vert {h}_{0} \vert}^{2} + {\vert {h}_{1} \vert}^{2}} \\ {\hat{S}}_{1} = {S}_{1} + \frac{( {h}_{0}^{⋆} {q}_{0} {Z}_{1} + {h}_{1} {q}_{1}^{⋆} {Z}_{3}}{{\vert {h}_{0} \vert}^{2} + {\vert {h}_{1} \vert}^{2}} \qquad [ Equation 3 ]$$

Referring to Equation 3, the reception symbols (Ŝ₀,Ŝ₁) include different interference symbols acting as interference, which means that interference changes by each symbol in the semi-static interval. Accordingly, it is possible to secure interference diversity for a packet and to improve diversity performance.

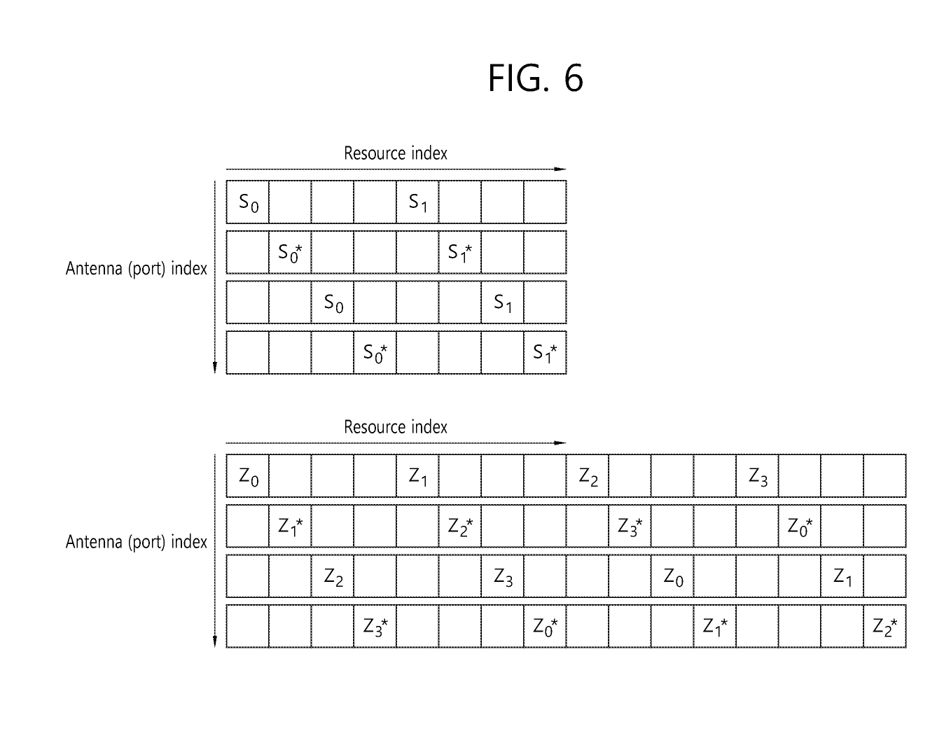

FIG. 6 illustrates a symbol pattern according to one embodiment of the present invention.

FIG. 6 shows space time block codes (STBCs) used for a first cell and a second cell for inter-cell interference randomizing and inter-cell interference averaging.

A row of an STBC in the upper part of FIG. 6 may correspond to each antenna of the first cell, and a row of an STBC in the lower part of FIG. 6 may correspond to each antenna of the second cell. A column of the upper STBC may correspond to a transmission resource (time resource or frequency resource) of the first cell, and a column of the lower STBC may correspond to a transmission resource (time resource or frequency resource) of the second cell.

FIG. 6 illustrates that two transmitting ends (cells) have four antennas, and the present invention may be applied in a similar manner when the number of antenna ports is 6 or N. In this case, the transmitting ends of the respective cells may precode a symbol using different precoders.

As illustrated, while the first cell repetitively transmits symbols S₀ and S₀*, the second cell transmits different symbols Z₀, Z₁*, Z₂*, and Z₃*, thereby changing a pattern of repeated symbols.

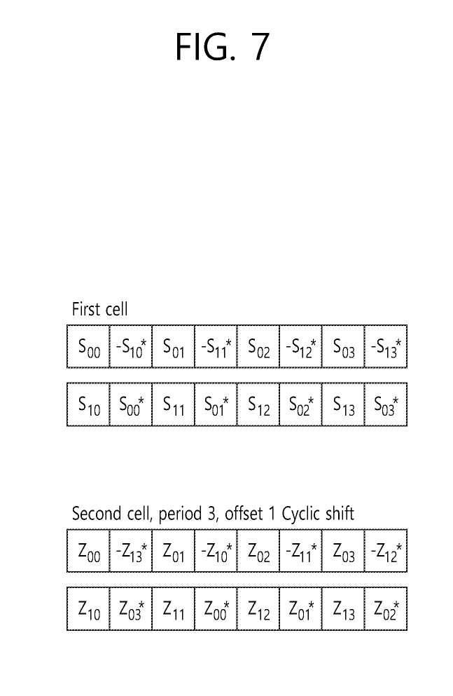

FIG. 7 illustrates a symbol pattern according to another embodiment of the present invention.

As illustrated, the present embodiment illustrates a symbol pattern applied to a full rank STBC or space frequency block code (SFBC).

Each cell may allocate symbols to all components of all resource indexes. While a first cell transmits symbols S₀₀, −S₁₀*, S₁₀, and S₀₀* through two antennas, a second cell transmits symbols Z₀₀, −Z₁₃*, Z₁₀, and Z₀₃* through antennas.

In the second cell, a symbol pattern iteration period is 3 and a symbol pattern is cyclic-shifted with an offset of 1.

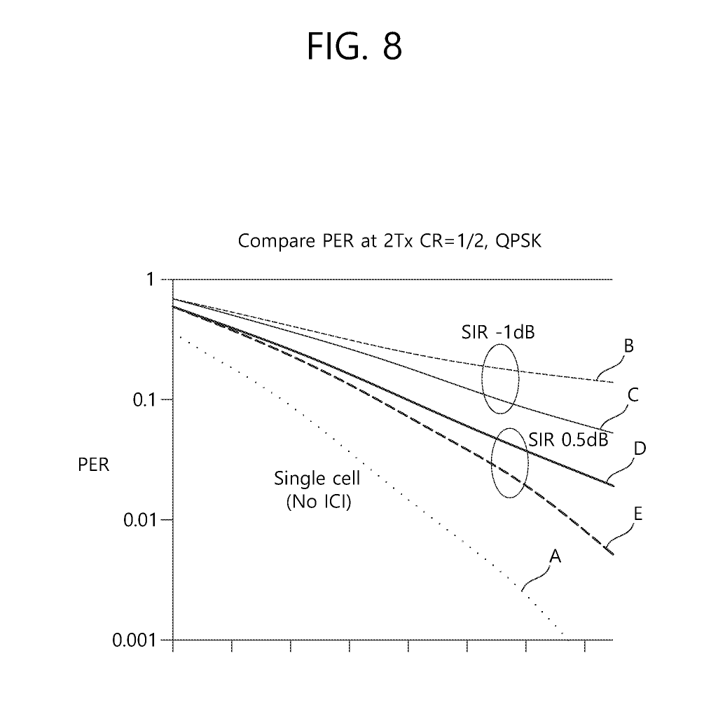

FIG. 8 is a graph illustrating a packet error rate (PER) according to a signal-to-noise ratio (SNR) in the case where interference diversity is achieved according to one embodiment of the present invention.

In FIG. 8, the PER represents packet error rate, which is a result of simulation in conditions where packet size is 94 REs on the assumption that one moving cell causes interference in one small cell, a symbol is modulated using QPSK and a convolution code, and a coding rate is 1/2.

The PER tends to decrease with an increase in SNR. As the PER decreases to a greater extent, signal received performance is better.

Curve A illustrated at the lowest in FIG. 8 represents a PER according to an SNR in the absence of interference, that is, in a case where a signal is received from a single cell. Curve A may be reference for comparing the performance of other curves.

Curve B and curve C show a case with an SIR of 1 dB, and curve D and curve E shows a case with an SIR of 0.5 dB. Curve B and curve D represent a PER change according to the convention method, that is, in a case where the symbol pattern of FIG. 4 is received, while curve C and curve E represent a PER change in a case where interference diversity according to the present invention is applied.

As illustrated, curve C and curve E incline more similarly to curve A in the absence of interference than curve B and curve D, respectively. When the symbol pattern of FIG. 5 is applied, a PER changes more similarly to curve A than a conventional PER, which indicates that signal received performance increases when the symbol pattern of FIG. 5 with interference diversity applied according to the present invention is applied as compared with when the symbol pattern of FIG. 4 is applied.

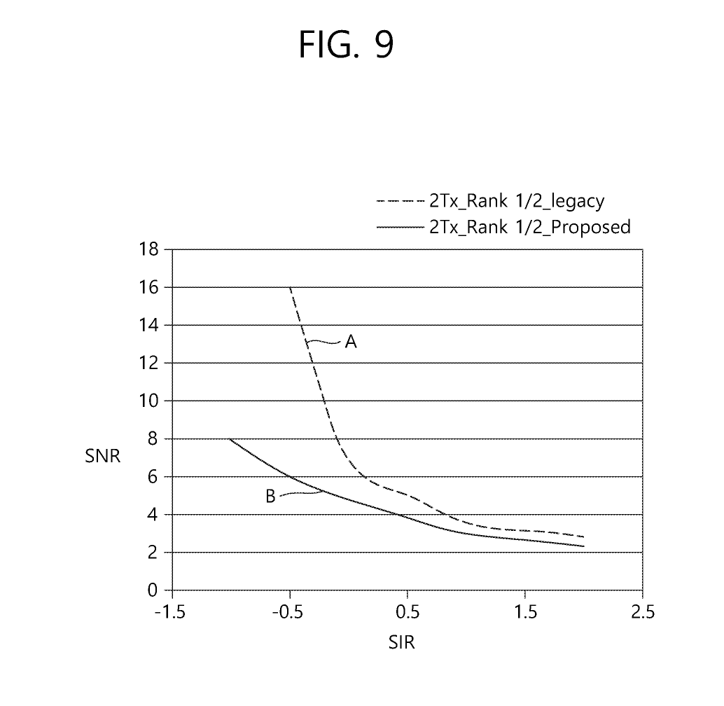

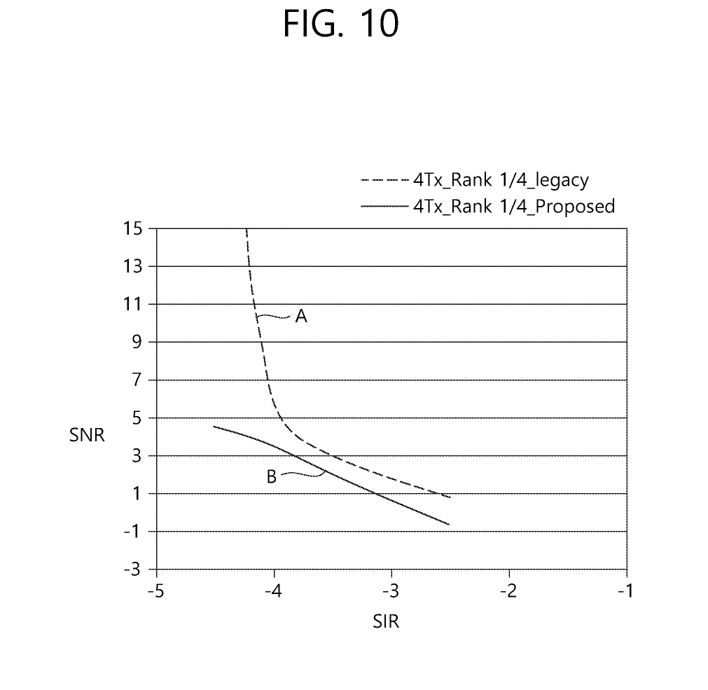

FIG. 9 and FIG. 10 are graphs illustrating an SNR according to an SIR in a case where a symbol pattern is applied according to the present invention.

FIG. 9 illustrates a case with two transmitting antenna ports, and FIG. 10 illustrates a case with four transmitting antenna ports.

In FIG. 9 and FIG. 10, curve A represents an SNR versus an SIR according to a convention method, and curve B represents an SNR versus an SNR according to the symbol pattern of FIG. 5.

The SNR tends to increase with a decrease in SIR. According to a legacy symbol pattern, SNR drastically decreases with strong interference, that is, low SIR. On the contrary, according to the symbol pattern of the present invention, it is shown that SNR gradually increases with an increase in interference strength (that is, an SIR decrease).

This indicates that the present invention allows stably securing an SNR in an environment of strong inter-cell interference. The present invention provides similar or superior received signal performance as compared with the convention method.

Hereinafter, a specific precoding design method for mitigating inter-cell interference is described.

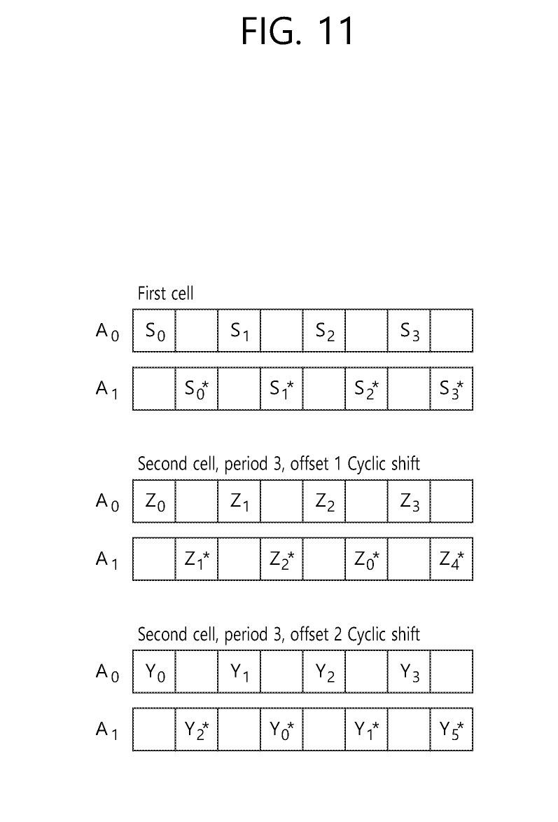

FIG. 11 illustrates a symbol pattern according to still another embodiment of the present invention. Specifically, FIG. 11 illustrates that each BS, that is, each cell, performs precoding using different repetitive patterns in when symbols are repeated.

As illustrated, a first cell sequentially transmits symbols S and modified symbols S* of the symbols S with respect to the same signal through different antennas. That is, when symbol S0 is transmitted through antenna 1 (A0), symbol S0* is transmitted through antenna 2 (A1). Further, when symbol S1 is sequentially transmitted through antenna 1 (A0), symbol S₁* is transmitted through antenna 2 (A1).

A pattern of repeated symbols by the first cell may be represented as a precoding matrix by Equation 4 or Equation 5.

$$\begin{matrix}[ \begin{matrix}{x}_{n} & 0 \\ 0 & {x}_{n}^{⋆}\end{matrix} ] & [ Equation 4 ] \\ [ \begin{matrix}{x}_{3 k} & 0 & {x}_{3 k + 1} & 0 & {x}_{3 k + 2} & 0 \\ 0 & {x}_{3 k} & 0 & {x}_{3 k + 1} & 0 & {x}_{3 k + 2}\end{matrix} ] & [ Equation 5 ]\end{matrix}$$

On the contrary, a second cell may modify a symbol pattern as illustrated in the middle part or lower part of FIG. 11. The second cell may repetitively transmit the symbol patterns through two antennas with a period of 3 and an offset set for the order of transmitted symbols.

In the middle symbol pattern in FIG. 11, the number of symbols in a repetitive pattern is 3, that is, the period is 3, and the offset of the order of transmitted symbols is set to 1. That is, symbols Z₀, Z₁, Z₂, Z₃, etc. may be sequentially transmitted through antenna 1 (A0), and modified symbols thereof may be transmitted through antenna 2 (A1) in a sequence of Z₁*, Z₂*, Z₀*, Z₄*, etc., instead of the preceding sequence of Z₀, Z₁, Z₂, Z₃, etc.

This pattern may be represented as a precoding matrix by Equation 6.

$$[ \begin{matrix}{x}_{3 k} & 0 & {x}_{3 k + 1} & 0 & {x}_{3 k + 2} & 0 \\ 0 & {x}_{3 k + 1} & 0 & {x}_{3 k + 2} & 0 & {x}_{3 k}\end{matrix} ] \qquad [ Equation 6 ]$$

In the lower symbol pattern in FIG. 11, the number of symbols in a repetitive pattern is 3, that is, the period is 3, and the offset of the order of transmitted symbols is set to 2. That is, symbols Y₀, Y₁, Y₂, Y₃, etc. may be sequentially transmitted through antenna 1 (A0), and modified symbols thereof may be transmitted through antenna 2 (A1) in a sequence of Y₂*, Y₀*, Y₁*, Y₅*, etc., instead of the preceding sequence of Y₀, Y₁, Y₂, Y₃, etc.

This pattern may be represented as a precoding matrix by Equation 7.

$$[ \begin{matrix}{x}_{3 k} & 0 & {x}_{3 k + 1} & 0 & {x}_{3 k + 2} & 0 \\ 0 & {x}_{3 k + 2} & 0 & {x}_{3 k} & 0 & {x}_{3 k + 1}\end{matrix} ] \qquad [ Equation 7 ]$$

The same offset or different offsets may be applied to respective cells, and the same period or different periods may be applied to respective cells.

Further, cells using the same transmitting antenna port may use different sizes of precoders according to a cyclic shift period.

For example, in Equation 6 or Equation 7, a cyclic shift period of symbol repetition may be 3, which may be 4 or greater. When the period is set, an offset may be set to a value of up to “period-1.”

In precoding a signal, cells, which may act as interference resources to each other, may preset a procoder as in Equations 4 to 7 to variously modify a repetitive pattern of symbols. Accordingly, interference diversity may be secured, thus improving signal received capability and preventing a decrease in the performance of a received signal by strong interference.

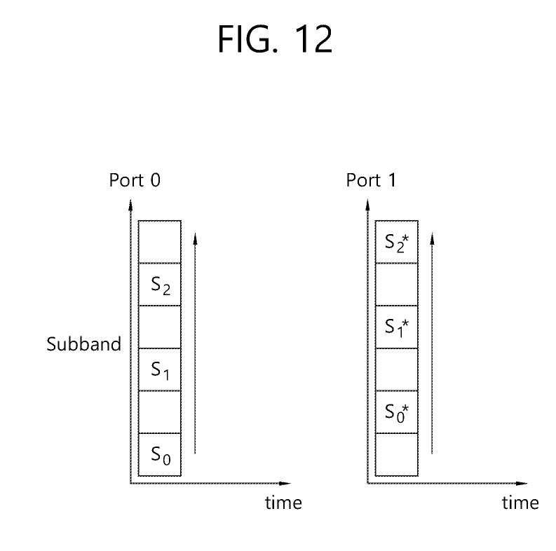

FIG. 12 illustrates resource allocation by the first cell according to FIG. 11.

According to FIG. 12, the first cell may sequentially map symbol to a frequency (subband) after precoding using Equation 4 or Equation 5.

Symbols S₀, S₁, S₂, S₃, etc. allocated to frequency resources are transmitted to a terminal through antenna port 0. Further, modified symbols (S₀*, S₁*, S₂*, S₃*) of the symbols transmitted through antenna port 0 may sequentially be allocated to different frequency bands to be transmitted to the terminal during the same time period through antenna port 1.

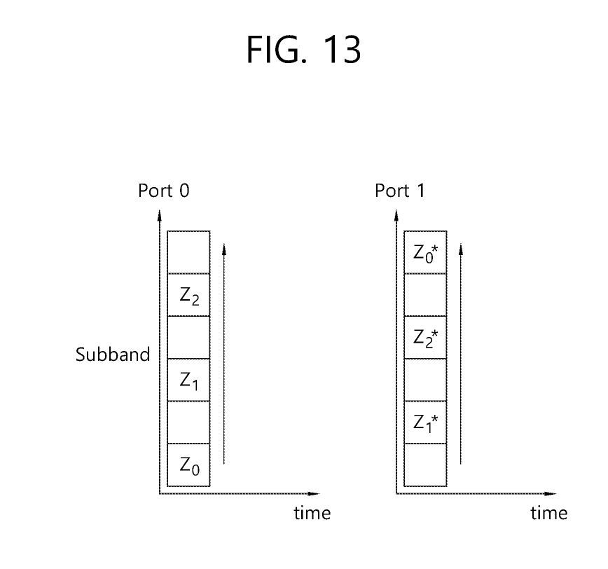

FIG. 13 illustrates one embodiment of resource allocation by the second cell according to FIG. 11.

According to one embodiment of the present invention, when an offset for the order of transmitted symbols is 1 among symbol patterns for the second cell in FIG. 11, resources may be mapped as in FIG. 13.

A BS responsible for the second cell may modify a repetitive pattern of symbols through hopping or scrambling by each antenna after precoding using Equation 6 and may allocate the modified symbol pattern to frequency resources as in FIG. 13.

Symbols Z₀, Z₁, Z₂, etc. allocated to the frequency resources are transmitted to a terminal through antenna port 0. Further, modified symbols (Z₁*, Z₂*, Z₀*, etc.) may be allocated to different frequency bands to be transmitted to the terminal during the same time period through antenna port 1 in an order obtained by applying an offset of 1 to the order of the transmitted symbols through antenna port 0.

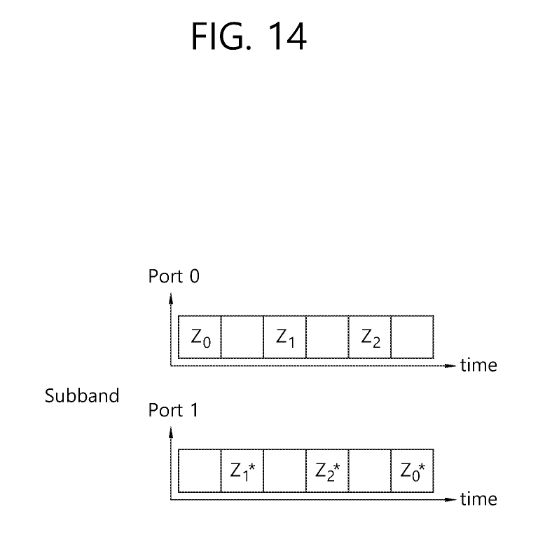

FIG. 14 illustrates another embodiment of resource allocation by the second cell according to FIG. 11.

As illustrated, according to the present embodiment, the BS responsible for the second cell may allocate a symbol pattern to time-axis resources, not to frequency-axis resources.

The BS responsible for the second cell may modify a repetitive pattern of symbols through hopping or scrambling by each antenna after precoding using Equation 6 and may allocate the modified symbol pattern to time resources as in FIG. 14.

Symbols Z₀, Z₁, Z₂, etc. allocated to the time resources are transmitted to a terminal through antenna port 0. Further, modified symbols (Z₁*, Z₂*, Z₀*, etc.) may be allocated to different time bands in the same frequency band to be transmitted to the terminal through antenna port 1 in an order obtained by applying an offset of 1 to the order of the transmitted symbols through antenna port 0.

In this case, the first cell may also allocate a symbol pattern to time resources, not to frequency resources.

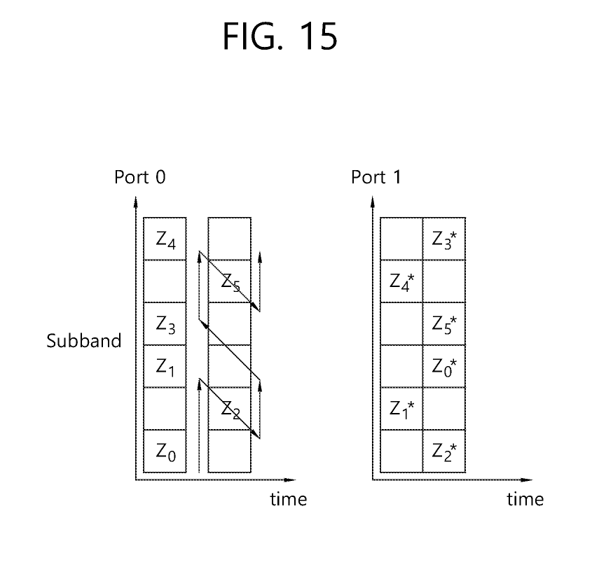

FIG. 15 illustrates still another embodiment of resource allocation by the second cell according to FIG. 11.

In FIG. 13 or FIG. 14, interference diversity is modified according to the frequency axis or time axis. When it is uncertain whether to apply interference diversity according to frequency or time, symbols may be allocated using both frequency resources and time resources according to the present embodiment. That is, FIG. 15 illustrates that the second cell two-dimensionally maps symbols.

When transmitting symbols Z0, Z1, Z2, Z3, Z4, Z5, etc. through antenna port 0, the second cell may map the symbols to the frequency axis and the time axis in a zigzag form.

In this case, modified symbols (Z₀*, Z₁*, Z₂*, Z₃*, Z₄*, Z₅*) transmitted through antenna port 1 may be allocated to resources that are not allowed to antenna port 0 as in FIG. 15.

The order of symbols allocated to the resources for antenna port 1 is not limited to FIG. 15, and a cyclic-shifted symbol pattern period or an offset of a symbol order may be variously changed.

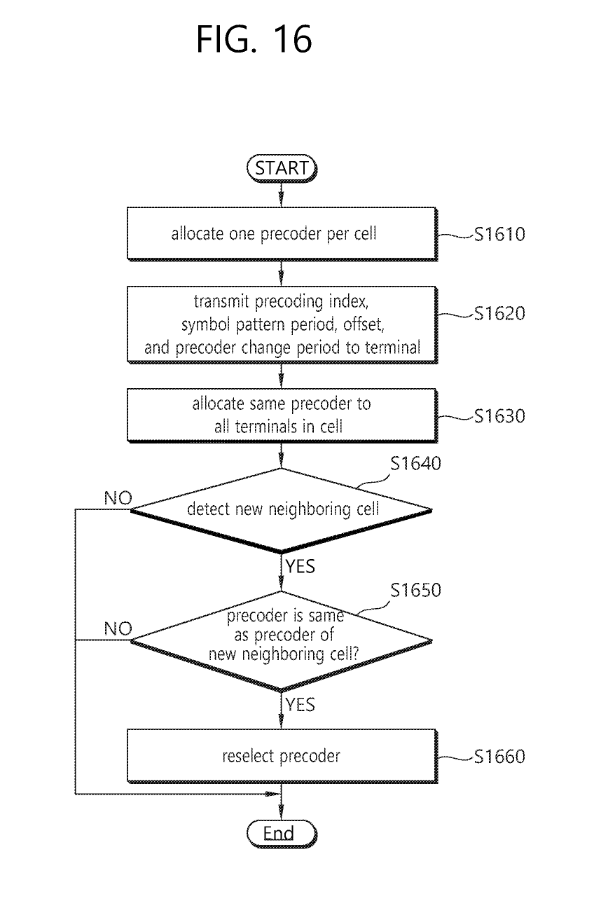

FIG. 16 is a control flowchart illustrating a precoder allocation method according to one embodiment of the present invention.

First, according to the present embodiment, one precoder may be allocated per cell (S1610).

When one precoder per cell is allocated, a BS transmits a precoding index, a symbol pattern period, an offset, and a precoder change period to a terminal via system information (SI) (S1620).

The BS may allocate the same precoder to all terminals managed by the BS in the cell (S1630).

When a new neighboring cell is detected (S1640), the BS may determine whether the precoder is the same as that of the detected new neighboring cell (S1650).

As a result of determination, when the precoder of the new neighboring cell is the same as the precoder applied to the cell managed by the BS, the BS may reselect a precoder based on a specific order or pattern (S1660). The BS may reselect a precoder using a cell ID and a random parameter K as an offset, that is, cell ID+K.

According to the present embodiment, the number of precoders used by the BS may be selected according to a cell ID, and the BS may periodically change a precoder at random.

When a precoder is selected according to a cell ID, the number of precoders may be smaller than the number of cell IDs. Meanwhile, with a longer period of a symbol pattern applied to a precoder, it may be efficient for signal transmission that the BS changes a precoder at random.

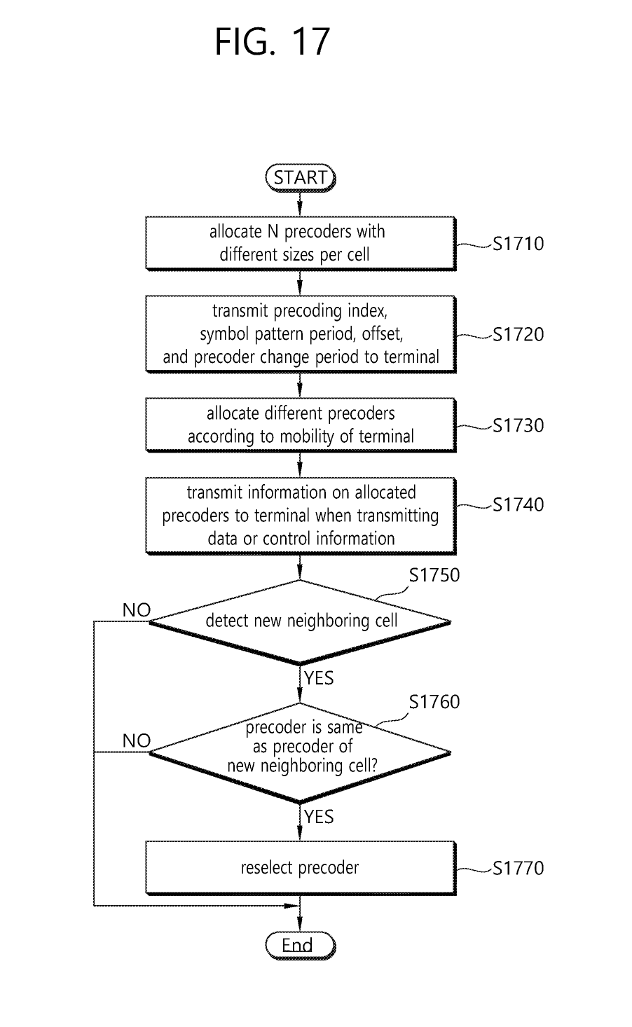

FIG. 17 is a control flowchart illustrating a precoder allocation method according to another embodiment of the present invention.

According to the present embodiment, a precoder for each cell may be changed periodically.

Each BS may allocate N precoders (N is an integer of 1 or greater) with different sizes per cell (S1710). When the N precoders are allocated, the BS transmits a precoding index, a symbol pattern period, an offset, and a precoder change period to a terminal via system information (SI) (S1720).

The BS may allocate different precoders according to the mobility of a terminal managed by the BS in a cell (S1730).

Here, the BS may transmit information on the allocated precoders to the terminal when transmitting data or control information (S1740).

When a new neighboring cell is detected (S1750), the BS may determine whether the precoder is the same as that of the detected new neighboring cell (S1760).

As a result of determination, when the precoder of the new neighboring cell is the same as the precoder applied to the cell managed by the BS, the BS may reselect a precoder based on a specific order or pattern (S1770). The BS may reselect a precoder using a cell ID and a random parameter K as an offset, that is, cell ID+K.

According to the present embodiment, the number of precoders used by the BS may be selected according to a cell ID, and the BS may periodically change a precoder at random.

When a precoder is selected according to a cell ID, the number of precoders may be smaller than the number of cell IDs. Meanwhile, with a longer period of a symbol pattern applied to a precoder, it may be efficient for signal transmission that the BS changes a precoder at random.

Meanwhile, the BS may dynamically allocate a transmission diversity precoder. That is, the BS may directly transmit a precoding index to the terminal, instead of following a specific rule as in FIG. 16 or FIG. 17. In this case, the BS may transmit the precoding index to the terminal through a designated pilot signal.

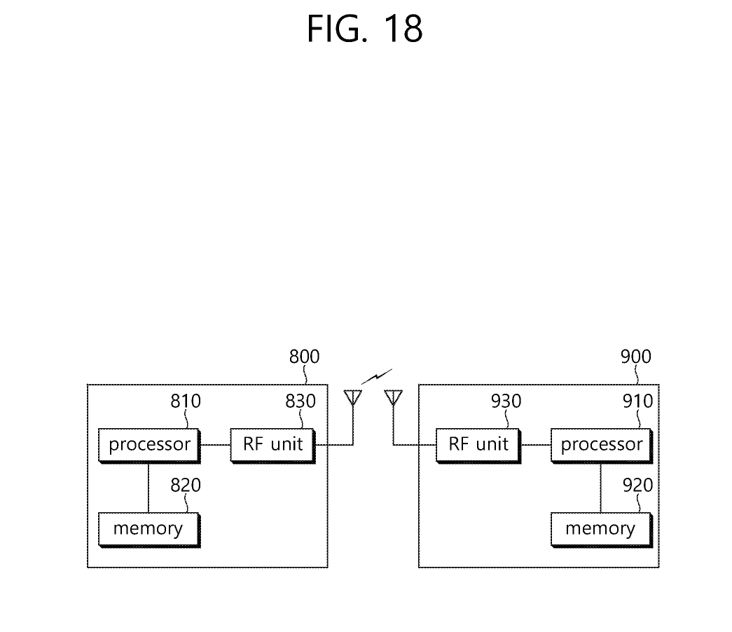

FIG. 18 is a block diagram of a wireless communication system according to one embodiment of the present invention.

ABS 800 includes a processor 810, a memory 820, and a radio frequency (RF) unit 830. The processor 810 implements the proposed functions, procedures, and/or methods. Layers of wireless interface protocols may be implemented by the processor 810. The memory 820 is connected with the processor 810 and stores various pieces of information to operate the processor 810. The RF unit 830 is connected with the processor 1110 and transmits and/or receives radio signals.

A terminal 900 includes a processor 910, a memory 920, and a radio frequency (RF) unit 930. The processor 910 implements the proposed functions, procedures, and/or methods. Layers of wireless interface protocols may be implemented by the processor 910. The memory 920 is connected with the processor 910 and stores various pieces of information to operate the processor 910. The RF unit 930 is connected with the processor 1110 and transmits and/or receives radio signals.

The processor may include an application-specific integrated circuit (ASIC), a separate chipset, a logic circuit, and/or a data processing unit. The memory may include a read-only memory (ROM), a random access memory (RAM), a flash memory, a memory card, a storage medium, and/or other equivalent storage devices. The RF unit may include a base-band circuit for processing a radio signal. When the embodiment of the present invention is implemented in software, the aforementioned methods can be implemented with a module (i.e., process, function, etc.) for performing the aforementioned functions. The module may be stored in the memory and may be performed by the processor. The memory may be located inside or outside the processor, and may be coupled to the processor by using various well-known means.

As described above, the present invention provides a method and a device enabling a terminal to select a wireless node for an uplink according to a predetermined condition when wireless connection is possible through different wireless networks.

In the above-described exemplary system, although the methods have been described in the foregoing embodiments on the basis of a flowchart in which steps or blocks are listed in sequence, the steps of the present invention are not limited to a certain order. Therefore, a certain step may be performed in a different step or in a different order or concurrently with respect to that described above. Further, it will be understood by those ordinary skilled in the art that the steps of the flowcharts are not exclusive. Rather, another step may be included therein or one or more steps may be deleted within the scope of the present invention.

1. A method for mitigating cell interference, the method comprising:
when a transmission symbol to be transmitted to a first receiver is Sₖ (k is an integer) and a transmission symbol to be transmitted to a second receiver is Zₖ (k is an integer),
a first signal transmission operation of transmitting a symbol Sₖ to the first receiver through a first transmitting antenna and transmitting a symbol Sₖ* to the first receiver through a second transmitting antenna, according to a first pattern; and
a second signal transmission operation of transmitting a symbol Zₖ to the second receiver through a third transmitting antenna and transmitting a symbol Zₖ* to the second receiver through a fourth transmitting antenna, according to a second pattern that is different from the first pattern.

2. The method of claim 1, wherein the first signal transmission operation comprises: transmitting a sequence {S₃ₖ, 0, S₃ₖ₊₁, 0, S₃ₖ₊₂, 0} to the first receiver through the first transmitting antenna; and transmitting a sequence {0, S₃ₖ*, 0, S₃ₖ₊₁*, 0, S₃ₖ₊₂*} through the second transmitting antenna, and
the second signal transmission operation comprises: transmitting a sequence {Z₃ₖ, 0, Z₃ₖ₊₁, 0, Z₃ₖ₊₂, 0} to the second receiver through the third transmitting antenna; and transmitting a sequence {0, Z₃ₖ₊₁*, 0, Z₃ₖ₊₂*, 0, Z₃ₖ*} through the fourth transmitting antenna.

3. The method of claim 1, wherein the first signal transmission operation comprises: transmitting a sequence {S₃ₖ, 0, S₃ₖ₊₁, 0, S₃ₖ₊₂, 0} to the first receiver through the first transmitting antenna; and transmitting a sequence {0, S₃ₖ*, 0, S₃ₖ₊₁*, 0, S₃ₖ₊₂*} through the second transmitting antenna, and
the second signal transmission operation comprises: transmitting a sequence {Z₃ₖ, 0, Z₃ₖ₊₁, 0, Z₃ₖ₊₂, 0} to the second receiver through the third transmitting antenna; and transmitting a sequence {0, Z₃ₖ₊₂*, 0, Z₃ₖ*, 0, Z₃ₖ₊₁*} through the fourth transmitting antenna.

4. The method of claim 2, wherein the sequence is allocated to a frequency resource.

5. The method of claim 2, wherein the sequence is allocated to a time resource.

6. The method of claim 1, wherein the first pattern and the second pattern are changed according to a predetermined period.

7.-11. (canceled)

12. A method for mitigating cell interference, the method comprising:
transmitting, by a base station (BS) in a cell, a precoding index, a symbol pattern period, an offset of a symbol order, and a precoder change period to a terminal when a precoder per cell is allocated;
allocating, by the BS, the precoder to all terminals in the cell;
determining, by the BS, whether the precoder is the same as a precoder of a neighboring cell when the neighboring cell is detected; and
reselecting a precoder based on a cell ID and the offset of the symbol order, when the precoder is the same as the precoder of the neighboring cell.

13. The method of claim 12,
wherein the number of precoders used by the BS is selected according to the cell ID,
wherein the number of the precoders is smaller than the number of cell IDs.

14. The method of claim 13,
wherein the precoder is changed periodically according to the precoder change period.

15. The method of claim 12,
wherein the symbol pattern period is cyclic shifted with the offset of the symbol order.

16. The method of claim 12,
wherein the precoding index is transmitted to the terminal through a predetermined pilot signal.

17. A method for mitigating cell interference, the method comprising:
transmitting, by a base station (BS) in a cell, a precoding index, a symbol pattern period, an offset of a symbol order, and a precoder change period to a terminal when a plurality of precoders with different sizes per cell is allocated;
allocating, by the BS, different precoders to terminals in the cell according to a mobility of the terminals;
transmitting, by the BS, information on the allocated precoders to the terminal when the BS transmits data or control information;
determining, by the BS, whether the precoder is the same as a precoder of a neighboring cell when the neighboring cell is detected; and
reselecting a precoder based on a cell ID and the offset of the symbol order, when the precoder is the same as the precoder of the neighboring cell.

18. The method of claim 17,
wherein the number of precoders used by the BS is selected according to the cell ID,
wherein the number of the precoders is smaller than the number of cell IDs.

19. The method of claim 18,
wherein the plurality of precoders are changed periodically according to the precoder change period.

20. The method of claim 17,
wherein the symbol pattern period is cyclic shifted with the offset of the symbol order.

21. The method of claim 17,
wherein the precoding index is transmitted to the terminal through a predetermined pilot signal.
